(19) United States
(12) Patent Application Publication
(10) Pub. No.: US 2019/0099877 A1
(43) Pub. Date: Apr. 4, 2019

(54) Exoskeleton System

(71) Applicant: Airbus Operations GmbH, Hamburg (DE)

(72) Inventors: Robert Alexander Goehlich, Hamburg (DE); Ingo Krohne, Hamburg (DE); Philipp Schneider, Hamburg (DE)

(73) Assignee: Airbus Operations GmbH, Hamburg (DE)

(21) Appl. No.: 16/140,813

(22) Filed: Sep. 25, 2018

(30) Foreign Application Priority Data
Sep. 29, 2017 (DE) 10 2017 122 755.5

(51) Int. Cl. B25J 9/00; B25J 9/16

(52) U.S. Cl. CPC B25J 9/0006; B25J 9/1664

(57) ABSTRACT

An exoskeleton system for supporting a person during an installation process includes a first exoskeleton unit for stabilizing a first body part of the person and a second exoskeleton unit for stabilizing a second body part of the person. Furthermore, the exoskeleton system includes a detection unit which is configured to detect a condition of the first body part and a control unit which is configured to control the second exoskeleton unit based on the detected condition of the first body part such that a specified condition of the second body part is adjusted by the second exoskeleton unit.

### FIELD OF THE INVENTION

The invention generally relates to the improvement of installation processes. In particular, the invention relates to an exoskeleton system for supporting a person during an installation process, to a working environment for supporting a person during an installation process as well as to a method for supporting a person during an installation process.

### BACKGROUND OF THE INVENTION

In nowadays installation systems, most of the working steps are carried out manually by the installation personnel, i.e., the technicians. During the installation and assembly processes, the technicians are often required to adapt difficult body postures. For example, difficult accessible regions in which the technicians must knee on the ground generally make the work more exhausting. Furthermore, technicians often carry out overhead work in which the technician puts the head into the neck and looks to the top. This is especially exhausting if the technician is required to hold such postures until a certain working step is completed and therefore over a relatively long time span.

DE 10 2015 101 329 A1 describes a support device, in particular an assembly support device for stabilizing a body part of a person that includes a plurality of hinged-together elements designed to at least partially envelop a body part of a person, so that the plurality of hinged-together elements collectively forms a flexible shell for the body part of the person. The flexible shell is designed to transfer a portion of a load acting on the body part of the person in order to stabilize the body part of the person.

DE 10 2014 117 432 A1 describes an assembly supporting device for supporting a technician during the assembly of an aircraft or a spacecraft. The assembly supporting device comprises a mat with a plurality of chambers filled with a gas. The assembly supporting device further comprises a sensor unit designed to determine a respective current gas pressure in the individual gas-filled chambers. A pressure regulating unit can be used to set the respective gas pressure in the individual chambers as a function of the current gas pressure determined in the respective chambers.

### BRIEF SUMMARY OF THE INVENTION

An aspect of the present invention may provide an improved system for supporting a technician during an installation process.

According to a first aspect of the invention, an exoskeleton system for supporting a person during an installation process is provided. The exoskeleton system comprises a first exoskeleton unit for stabilizing a first body part of the person and a second exoskeleton unit for stabilizing a second body part of the person. The exoskeleton system further comprises a detection unit which is configured to detect a condition of the first body part and a control unit which is configured to control the second exoskeleton unit based on the detected condition of the first body part such that a condition of the second body part is adjusted by the second exoskeleton unit.

Such an exoskeleton system provides an individual and intuitive control of different body parts of the person wearing the exoskeleton system. In particular, the exoskeleton system makes it possible to support the technician during an installation work in which difficult body postures are required to complete a specific working step. For example, if the technician carries out an overhead work, the technician usually has to put the head into the neck. In order to make this body posture more comfortable for the technician, the exoskeleton system is controlled such that, for example, the arms of the technician are supported by moving them into an upward direction. Therefore, the exoskeleton system has a first exoskeleton unit for detecting the movement of the head and another exoskeleton unit for supporting the movement of the arms in the upward direction. Such examples will be described in more detail in the description of the drawings.

The inventive exoskeleton system provides a selective support of exoskeleton units only when this is needed. Further, a personalization of supporting functions, i.e., depending on the user constitution or needs, is possible. The system may further comprise a safety function due to a possible interaction with other technical systems in the surrounding environment, e.g., a human-robot-interaction. The system may also comprise a learning function, for example by reading out movement and control data stored during previous installation processes.

The combined control of the exoskeleton units results in a healthier and safer work for technicians during installation processes.

An exoskeleton system may be understood as an exoskeleton which is also known as powered armor, power armor, exoframe, hardsuit, or exosuit. The exoskeleton system may particularly be understood as a wearable mobile machine. This machine may be powered by a system of electric motors, pneumatics, levers, hydraulics, or a combination thereof. The exoskeleton system may allow for limb movement with increased strength and endurance.

The exoskeleton system may comprise a plurality of exoskeleton units which are independently movable relative to each other. In particular, these exoskeleton units may be independently controllable relative to each other. It is possible that each of the plurality of exoskeleton units correspond to distinct body part of the person. This means that an exoskeleton unit may be adapted to the normal shape of the respective body part.

The first exoskeleton unit and the second exoskeleton unit may each comprise a shell-like structural component which at least partly surrounds the corresponding body parts. The shell like structural component is configured to support and move the body part if a control command is sent to the first exoskeleton unit or the second exoskeleton unit. The exoskeleton units may be rigid or flexible components which may adapt the shape of a body part of the person. For example, the shell-like structural component is aligned or adapted to a contour of the respective body part. However, the exoskeleton units may be rigid enough to provide a support for the respective body part to be supported by the exoskeleton unit. The exoskeleton units may comprise cushions or pads inside the shell-like structural component which provides more comfort for a person wearing the exoskeleton units.

It is possible that the exoskeleton units comprise struts or frameworks for stabilizing the body parts. The struts or frameworks may be aligned or adapted to the contour of the respective body parts. Different exoskeleton units may be connected to each other by means of mechanical joints, or example articulated joints as will be described in more detail below.

The first exoskeleton unit and the second exoskeleton unit may be arranged spatially separate on the person, i.e., the exoskeleton units are not mechanically connected with each other which means that the exoskeleton units are only connected via other body parts of the person. In another example, the exoskeleton units may be connected or coupled via mechanical joints.

The exoskeleton system comprises a detection unit. In particular, the first exoskeleton unit may comprise the detection unit such that a detection of the condition of the first body part of the person is possible. The detection unit may comprise at least one sensor which is configured to detect or measure the condition of the first body part. The condition to be detected may be a position, orientation or movement of the first body part carried out by the person. Therefore, the detection unit is configured to detect a movement of the first body part, a movement direction of the first body part, a movement force of the first body part and a movement velocity or acceleration of the first body part. It may also be possible that the detection unit is configured to detect a temperature of the first body part, a humidity of the first body part, in particular in the region of the first body part, or a pulse rate measured on the first body part. It is understood that the detection unit may also be configured to detect a combination of the mentioned conditions.

After detecting the condition of the first body part, data about the condition is provided to a control unit which may be arranged at one of the exoskeleton units or which may be an external unit that can be carried individually by the person or that is arranged separate to the person. The detected condition, in particular the data about the condition is processed by the control unit, which may be a computer or processing unit, and is then used to adjust a condition of the second body part. The condition of the second body part can be adjusted by the second exoskeleton unit based on the processed data about the condition of the first body part. In order to adjust this condition of the second body part, the control unit controls the second exoskeleton unit. The condition of the second body part to be adjusted by the second exoskeleton unit may be a position, orientation or movement of the second body part. Therefore, the control unit is configured to control a movement of the second body part, a movement direction of the second body part, a movement force of the second body part, a movement velocity or acceleration of the second body part. It may also be possible that the control unit is configured to control a temperature of the second body part or a humidity of the second body part. It is understood that the control unit may also be configured to adjust a combination of the mentioned conditions of the second body part by controlling the second exoskeleton unit. The adjustment of the condition also comprises a support of the condition to be adjusted which means that, if the second body part is moved by the person itself, a support of this movement of the second body part may be provided or facilitated by the controlled movement of the second exoskeleton unit. In this case, the person does not need to move the second body part alone but is instead supported by the second exoskeleton unit such that only a part of the weight or force required to move the second body part must be applied by the person.

A movement of the first body part may trigger a power supply to the first exoskeleton unit such that the first exoskeleton unit can be powered by this power supply. It is possible to adapt a specific amount of power which is supplied to the first exoskeleton unit. Accordingly, a power supply to the second exoskeleton unit can also be provided.

A movement of the exoskeleton units may be provided by a drive unit or an actuator which is, for example, arranged at the connection device or at the respective exoskeleton unit.

According to an embodiment of the invention, the detection unit is configured to detect a movement of the first body part which is supported by the first exoskeleton unit. The control unit is configured to adjust a movement of the second exoskeleton unit based on the detected movement of the first body part such that a movement of the second body part is supported by the adjusted movement of the second exoskeleton unit.

In this case, the condition detected by the detection unit is a movement of the first body part and the condition controlled by the control unit is an adjustment of the second body part. The adjustment of the movement of the second body part may include a change of the moving direction, moving velocity or moving force.

In this manner, the body posture of the person can be generally optimized for a specific working posture. For example, if an arm of the person moves forward, this can be detected by the detection unit of the first exoskeleton unit such that, by means of the control unit, the second exoskeleton unit is moved and thereby adjusts the movement of the second body part, for example the torso, such that the forward movement of the arm can be counterbalanced by a rearward movement of the torso. In the same way, different combinations of movements of different body parts are possible. This enhances, on the one hand, the comfort of the person using or wearing the inventive exoskeleton system and, on the other, improves the safety of the person since unhealthy or dangerous body postures can be avoided.

According to another embodiment of the invention, the control unit is configured to control the second exoskeleton unit based on the detected condition of the first body part only if the condition of the first body part is detected over a predetermined time span.

In this manner, it is possible to distinguish between volitional and accidental movements of the first body part and it can be avoided to trigger a movement of the second exoskeleton unit and with this the movement of the second body part based on the detected movement of the first body part in case the movement of the first body part was unintentional or accidental.

In another example, the control unit is configured to control the second exoskeleton unit based on the detected condition of the first body part only if the condition of the first body part is detected over a predetermined time span and a specified condition of a third body part is detected, for example by a detection unit of a third exoskeleton unit.

In a first mode, the person or user pushes a button arranged at the exoskeleton system or at the first exoskeleton unit, which activates the arm support of the first exoskeleton unit.

In a second mode, the user makes a hand grip giving a positive signal, for example from a glove exoskeleton, which in this case is the first exoskeleton unit, thereby activating an arm support exoskeleton, which in this case is the second exoskeleton unit.

In a third mode, the user makes a hand grip giving a positive signal in the first exoskeleton unit which triggers a delayed activation of the second exoskeleton unit. Accordingly, a delayed de-activating is carried out, for example, only when the hand of the user is empty for more than one second.

Therefore, the programming of the exoskeleton system can be as follows:

If the detection unit, e.g., the sensor is triggered for more than three seconds, the exoskeleton system is started and activated, in particular the relevant exoskeleton units are started. If the sensor is released for longer than one second, the exoskeleton system is stopped or deactivated. Otherwise, the exoskeleton system is not even started.

In a fourth mode, a hand grip of the user gives a positive signal and a delayed activation of half of the power of the exoskeleton system or first exoskeleton unit takes place, for example, only when the hand grip lasts for more than one second and at the same time a foot sensor signal is positive, i.e., measuring an increase in weight for both foots, for example of about 5 kg, which means that a condition of the second body part corresponding to the second exoskeleton unit or a condition of a third body part corresponding to a third exoskeleton unit is detected. Alternatively, a delayed activation of the full power takes place only when the hand grip lasts for more than ten seconds and at the same time a foot sensor signal is positive and a temperature sensor detects a temperature increase of about 0.5° C. within one minute. This implies that different conditions form different body parts can be detected based on which the condition of the second body part can be adjusted by means of the second exoskeleton unit.

In a fifth mode, a hand grip of the user gives a positive signal and an immediate or a delayed activation of half or full power depends on a previous condition or action of the first body part.

In a sixth mode, a hand grip of the user gives a positive signal and an immediate or a delayed activation of half or full power depends on a previous condition or action of the first body part, wherein furthermore user habits, preferences, relieving postures, etc. are considered. In other words, the exoskeleton system may have stored user-specific data which are, for example, representative for an optimized body posture for a specific user, an age of the user, diseases of the user, physical handicaps of the user or general preferred body postures as well as anatomical or physical data of the user. Furthermore, the exoskeleton system may have stored generic data which are not user-specific such as favorite ergonomic postures, pulse rates, etc. Generic data may be representative for conditions of a person that usually apply to all human beings. These user-specific data can also be used to control the second or first exoskeleton unit. In particular, the control unit may be configured to control the second exoskeleton unit based on the detected condition of the first body part and the user-specific data such that a specified condition of the second body part is adjusted by the second exoskeleton unit.

According to another embodiment of the invention, the control unit is configured to independently control the first exoskeleton unit and the second exoskeleton unit based on the detected condition of the first body part such that the condition of the second body part is independently supported by the second exoskeleton unit.

For example, it is possible to adjust a dependency of the movement of the second exoskeleton from the movement of the first exoskeleton unit. It is possible, that the first exoskeleton unit is movable completely independently from the second exoskeleton unit. The control unit may generally adjust the dependency of the movement of the second exoskeleton unit from the movement of the first exoskeleton unit. It is furthermore possible that the control unit can adjust the amount to which the movement of the second exoskeleton unit is dependent from the condition of the first exoskeleton unit and a third exoskeleton unit. In this manner, the movement of different body parts and therefore the movement of the corresponding exoskeleton units may have a different influence on the movement of the second exoskeleton unit and therefore the adjustment of the second body part.

According to another embodiment of the invention, the detected condition of the first body part is selected from a group, the group comprising a movement of the first body part, a movement direction of the first body part, a movement force of the first body part, a movement velocity of the first body part, a temperature of the first body part, a humidity of the first body part and a pulse rate measured on the first body part.

The term “condition” may therefore also be understood as an action or characteristic of the first body part. A combined detection of the mentioned conditions is possible.

According to another embodiment of the invention, the control of the second exoskeleton unit comprises a functional control selected from a group, the group comprising a control of a movement of the second exoskeleton unit, a control of a movement direction of the second exoskeleton unit, a control of a movement velocity of the second exoskeleton unit, a control of a heat emission to the second body part via the second exoskeleton unit.

The term “condition” may therefore also be understood as an action or characteristic of the second body part to be adjusted. A combined control or adjustment of the mentioned conditions is possible.

According to another embodiment of the invention, the first exoskeleton unit is arranged spatially separate to the second exoskeleton unit or the first exoskeleton unit is mechanically connected to the second exoskeleton unit via at least one mechanical connection unit, e.g., joint.

The first alternative defines that the first exoskeleton unit is arranged at the first body part of the person while not being mechanically connected to the second exoskeleton unit which is arranged at the second body part of the person. For example, this is usually the case when the first exoskeleton unit is arranged at an arm of the person and the second exoskeleton unit is arranged at a leg of the person and no other exoskeleton units connect the first and second exoskeleton units. A connection or coupling by other parts of the exoskeleton system is not present in this case. This means that the only physical connection between the first and second exoskeleton unit is the person itself.

The second alternative defines that the first exoskeleton unit is arranged at the first body part of the person and is connected to the second exoskeleton unit arranged at the second body part of the person while the first exoskeleton unit is connected or coupled to the second exoskeleton unit by means of a joint, in particular a hinge or an articulated joint. For example, this is the case when the first exoskeleton unit is arranged at a fore arm of the person and the second exoskeleton unit is arranged at an upper arm of the person. The connection unit is then located in the region of the elbow of the person.

According to another embodiment of the invention, the at least one mechanical connection unit for the connection between the first exoskeleton unit and the second exoskeleton unit comprises an articulated joint.

In this manner, a flexible exoskeleton system can be provided in which each of the exoskeleton units can be moved independently from each other. In particular, the exoskeleton units can be rotated against each other such that the relative orientation between the first exoskeleton unit and the second exoskeleton unit is changed. The connection may comprise several articulated joints which connect the first exoskeleton unit with the second exoskeleton unit.

According to another embodiment of the invention, the exoskeleton system comprises a plurality of exoskeleton units, wherein each of the plurality of exoskeleton units is configured for stabilizing a corresponding body part. The control unit is configured to independently control each of the exoskeleton units based on the detected condition of the first body part such that the corresponding body parts are independently supported by the plurality of exoskeleton units.

Thus, an interactive exoskeleton system can be provided in which each or almost each body part can adapt a condition, for example an orientation which is optimized for the condition of the first body part, for example the orientation of the first body part. As the different exoskeleton units of the plurality of exoskeleton units can be controlled independently, it is possible to adjust the magnitude or extent to which the control of an exoskeleton unit of the plurality of exoskeleton units is dependent on the condition of the first body part and therefore the condition of the first exoskeleton unit.

According to another embodiment of the invention, the control unit is configured to control the second exoskeleton unit based on boundary conditions such that a predetermined threshold value of the specified condition of the second body part is not exceeded. Furthermore, the control unit may be configured to control the second exoskeleton unit based on boundary conditions such that the specified condition of the second body part does not fall below a predetermined threshold value for the specified condition of the second body part.

For example, a maximum movement of the second body part is inhibited if the control unit detects that the threshold value for a certain movement has been reached. In an example, a further movement of the second body part relative to the first body part is inhibited if a threshold value for the maximum relative movement between these body parts is exceeded. It is possible that the threshold value defines a maximum moving velocity or a maximum moving force of the second body part. In such a case, the second exoskeleton unit inhibits exceeding the threshold value, for example by a countermovement.

The threshold value may also be defined by a maximum or minimum humidity value, a maximum or minimum temperature value or a maximum or minimum pulse rate of the second body part. In this case, the second exoskeleton unit adjusts or regulates these conditions such that the respective threshold values are not exceeded or such that the actual condition values do not fall below the respective threshold values.

It is possible that, if the value for a condition of the second body part exceeds or falls below the respective predetermined threshold value, a signal is generated by the control unit indicating that circumstance to the user, e.g., technician. The signal can be a visual, an optical, or a haptic signal. For example, the signal is a warning sound. An optical signal can be indicated by means of a display arranged at the exoskeleton system which visualizes the signal for the user.

The pulse of the person can be measured by sensors. For example, the pulse is measured at the start of the work. A tolerance margin for a pulse can be determined, for example based on user-specific data. If the measured actual pulse is higher than the maximum pulse or lower than the minimum pulse, the user will be informed and/or the exoskeleton system can be switched off. The measurement of the pulse of the person can be carried out in the hand region, in particular at the wrist.

According to another embodiment of the invention, the predetermined threshold of the specified condition of the second body part comprises user-specific data.

The user-specific data represents an anatomy of the person, diseases of the person and other relevant parameters which limit the possible and maximum movements of the exoskeleton units of the exoskeleton system.

According to another embodiment of the invention, the exoskeleton system, in particular the first exoskeleton unit and second exoskeleton unit are remotely controlled by another person or an external control system.

This is especially advantageous in rescue or in evacuation procedures in which a person wearing the exoskeleton system is unconscious and has to be rescued or evacuated. The exoskeleton system can then remotely controlled move the person out of the danger zone.

Furthermore, it is possible that the exoskeleton system, in particular the control unit can initiate a reanimation of the person wearing the exoskeleton system. Such a reanimation can be started if the detection unit detects that there is no pulse rate present on the person. The reanimation can also be remotely controlled.

Not least, the exoskeleton system ensures a safe movement of the person. For example, if the person falls down, the exoskeleton system can prevent the person from serious injuries by providing a dampened impact in a safe body posture.

According to another aspect of the invention, a working environment for supporting a person during an installation process is provided. The working environment comprises an exoskeleton system as described above and a robot system. The exoskeleton system further comprises a communication unit for communicating with the external robot system which is arranged spatially separate to the exoskeleton system. The control unit is configured to control the second exoskeleton unit based on a movement of the external robot system.

This prevents an interference or collision between the exoskeleton system and the robot system. The exoskeleton system and the robot system may be configured as separate systems which independently carry out work tasks, for example in an installation process.

The control unit can move the second exoskeleton unit or prevent a movement of the second exoskeleton unit such that a collision between the robot system and the exoskeleton system is avoided. For example, if the control unit recognizes based on communicated data from the robot system that a planned movement of the second exoskeleton unit would end up in a collision with the robot system, the control unit can inhibit a further movement of the second exoskeleton unit so as to avoid the collision.

If a possible collision is determined by the control unit, a signal can also be generated warning the user of the exoskeleton system.

The communication unit may be connected to the control unit. The communication unit may have a fail-safe logic implemented, be transparent for the user, and be made of lightweight materials. A wireless communication between the communication unit and other units and/or systems is enabled. A standard communication protocol will be established in order provide an interface to other data sources or users. The data exchanged can be used to see the status of different systems and exchange in terms to have a safe interaction. Moreover, the data can be communicated into a database for monitoring the system performance of the exoskeleton system such that the stored data can be used for optimization purposes. Additionally, this data can be applied for an individual optimization of the performance, in particular a learning of additional needs and an adaption to specific behaviors etc. The exoskeleton system, in particular the control unit can internally store user-specific data or obtain such data from cloud data. These data may contain information about user preferences, or generic data which generally apply for human beings. These data may further comprise motion sequences which are representative for a best movement of a specific user or for a best movement of an average human being. These data can be used by the exoskeleton system to optimize the movements of the different exoskeleton units of the system.

It is possible that, via the communication unit, a signal can be provided from the exoskeleton unit to the robot system or from the robot system to the exoskeleton system. This signal may prevent a collision of both systems. For example, the control unit can process the signals such that, via control signals to the systems, the collision can be avoided. Therefore, a collision avoidance system, as it is for example used for aircraft, can be implemented. Furthermore, a magnetic repulsion may be used to prevent the systems from collision.

The working environment may be an aircraft or a spacecraft. In particular, the working environment may be a fuselage of an aircraft or spacecraft.

According to another aspect of the invention, a method for supporting a person during an installation process is provided. In a step of the method, an exoskeleton system with a first exoskeleton unit and a second exoskeleton unit is provided. In another step, the person to be supported is equipped with the exoskeleton system by attaching the first exoskeleton unit to a first body part of the person and the second exoskeleton unit to a second body part of the person. In another step, a threshold value for a predetermined maximum movement of the first body part relative to the second body part is defined. This definition can be based on user-specific data which, for example, take an anatomy of the person into account. This maximum movement can also be learned during a learning procedure in which the person carries out the maximum possible movements to which the person is physically enabled. In another step, a movement of the first body part is inhibited by means of the first exoskeleton unit, when the threshold value for the maximum movement of the first body part relative to the second body part is exceeded.

The inventive method can be described in other words as follows:

First, the operator, e.g., the user or person is dressed in the exoskeleton system. Second the operator activates a so called safe-operation-mode. Third, the exoskeleton's control unit instructs the operator to bend his arms/legs/body part in a maximum possible manner. For example, the control unit instructs the user via a display to move the arms/legs or other body parts up, down, to the right side, to the left side such that the control unit can measure and determine the user's range of flexibility. Fourth, manual input on movement constraints can also be input by the user manually wherein the movement constraints may comprise data about a previous surgery in a body part, e.g., in the right arm. Based on these data, the system can determine, that the maximum movement of this arm is limited since the user prefers to move that arm less. Fifth, the control unit determines the maximum allowable movements. Sixth, the control unit gives a signal if the user is, due to his movements, close to the limits. If such a limit is reached, the exoskeleton system hinders the user to make that movement such that, for example, lifting a 40-kg-box in a wrong body posture is not possible. It is possible that the exoskeleton system initiates a counter movement in this case, thus bringing the user back to healthier and safer body postures.

### BRIEF DESCRIPTION OF THE DRAWINGS

FIG. 1 shows an exoskeleton system having different exoskeleton units according to an exemplary embodiment of the invention.

FIG. 2 schematically shows an exoskeleton system having different exoskeleton units according to another exemplary embodiment of the invention.

FIG. 3 schematically shows typical locations for connection units of an exoskeleton system according to an exemplary embodiment of the invention.

FIG. 4 A schematically shows a person wearing an exoskeleton system with an arm support according to an exemplary embodiment of the invention.

FIG. 4B schematically shows a person wearing an exoskeleton system with an arm support according to another exemplary embodiment of the invention.

FIG. 4C schematically shows an exoskeleton system with a neck support according to an exemplary embodiment of the invention.

FIG. 5 schematically shows two exoskeleton units and a connection unit according to an exemplary embodiment of the invention.

FIG. 6 schematically shows a fastening unit for fastening a control unit according to an exemplary embodiment of the invention.

FIG. 7 schematically shows a control and communication kit for an exoskeleton system according to an exemplary embodiment of the invention.

FIG. 8 schematically shows a fastening unit with a control and communication kit according to an exemplary embodiment of the invention.

FIG. 9 schematically shows a detailed view of a fastening unit according to an exemplary embodiment of the invention.

FIG. 10 schematically shows a cross-sectional view of a fastening unit according to an exemplary embodiment of the invention.

FIG. 11 schematically shows a top view of a control device for manually controlling an exoskeleton system according to an exemplary embodiment of the invention.

FIG. 12 schematically shows a side view of a control device for manually controlling an exoskeleton system according to an exemplary embodiment of the invention.

FIG. 13 schematically shows a humidity control inside a garment of a person wearing an exoskeleton system according to an exemplary embodiment of the invention.

FIG. 14 schematically shows a working environment for supporting a person during an installation process according to an exemplary embodiment of the invention.

FIG. 15 shows a flow diagram of a method for supporting a person during an installation process according to an exemplary embodiment of the invention.

### DETAILED DESCRIPTION

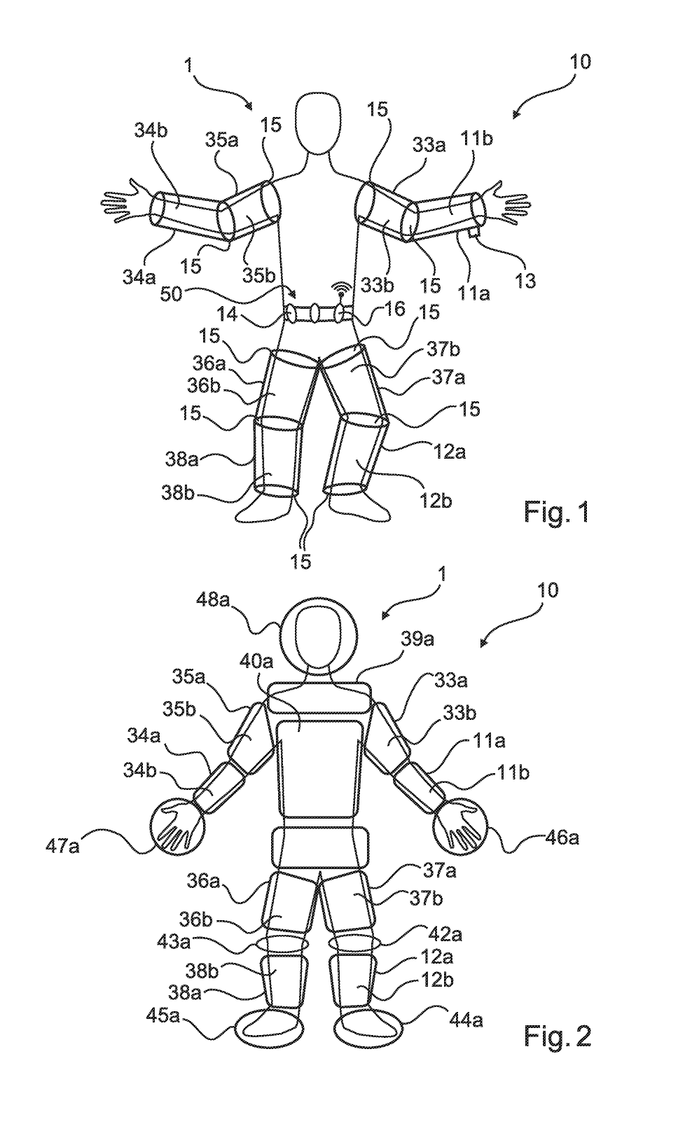

FIG. 1 shows an exoskeleton system 10 having a plurality of exoskeleton units 33a, 34a, 35a, 36a, 37a, 38a. Each of the plurality of exoskeleton units 33a, 34a, 35a, 36a, 37a, 38a is configured for stabilizing a corresponding body part 33b, 34b, 35b, 36b, 37b, 38b of the person. A control unit 14 of the exoskeleton system 10 is configured to independently control each of the exoskeleton units 33a, 34a, 35a, 36a, 37a, 38a based on a detected condition of the first body part 11b such that the corresponding body parts 33b, 34b, 35b, 36b, 37b, 38b are independently supported by the plurality of exoskeleton units 33a, 34a, 35a, 36a, 37a, 38a.

The exoskeleton system 10 comprises a first exoskeleton unit 11a for stabilizing a first body part 11b of the person 1 and a second exoskeleton unit 12a for stabilizing a second body part 12b of the person 1. Furthermore, the exoskeleton system 10 comprises a detection unit 13 which is configured to detect a condition of the first body part 11a. For example, the detection unit is a sensor which is configured to detect a movement of the first body part 11b, a movement direction of the first body part 11b, a movement force of the first body part 11b, a movement velocity of the first body part 11b, a temperature of the first body part 11b, a humidity of the first body part 11b, a pulse rate or a combination of these conditions. A control unit 14 of the exoskeleton system 10 is configured to control the second exoskeleton unit 12a based on the detected condition of the first body part 11b, that means based on the detected movement of the first body part 11b, the detected movement direction of the first body part 11b, the detected movement force of the first body part 11b, the detected movement velocity of the first body part 11b, the detected temperature of the first body part 11b, the detected humidity of the first body part 11b or the detected pulse rate measured on the first body part or another body part of the person, for example the wrist of the person. By controlling the second exoskeleton unit 12a based on the detected condition of the first body part 11b, a specified condition of the second body part 12b is adjusted by the second exoskeleton unit 12a.

The detection unit 13 is attached to the first exoskeleton unit 11a as shown in FIG. 1. However, the detection unit 13 can also be arranged at another exoskeleton unit 33a, 34a, 35a, 36a, 37a, 38a of the exoskeleton system 10 or at another body part 33b, 34b, 35b, 36b, 37b, 38b, for example if a remote detection of the condition of the first body part 11b is carried out. Therefore, the detection unit 13 may be configured to carry out a remote measurement of the condition of the first body part 11b.

The exoskeleton units 11a, 12a, 33a, 34a, 35a, 36a, 37a, 38a are connected to each other via connection units 15 or to other body parts of the person 1. For example, a connection unit 15 connects exoskeleton unit 11a and exoskeleton unit 33a. Furthermore, exoskeleton unit 33a is connected to the shoulder or to the torso of the person 1 by means of a connection unit 15. As can be gathered from FIG. 1, the exoskeleton system 10 comprises several exoskeleton units 11a, 12a, 33a, 34a, 35a, 36a, 37a, 38a which together at least partly enclose the body of the person 1. Only the body parts 11b, 12b, 33b, 34b, 35b, 36b, 37b, 38b are supported by respective exoskeleton units 33a, 34a, 35a, 36a, 37a, 38a. However, it is possible that the whole body of the person is enclosed or supported by the exoskeleton units 11a, 12a, 33a, 34a, 35a, 36a, 37a, 38a.

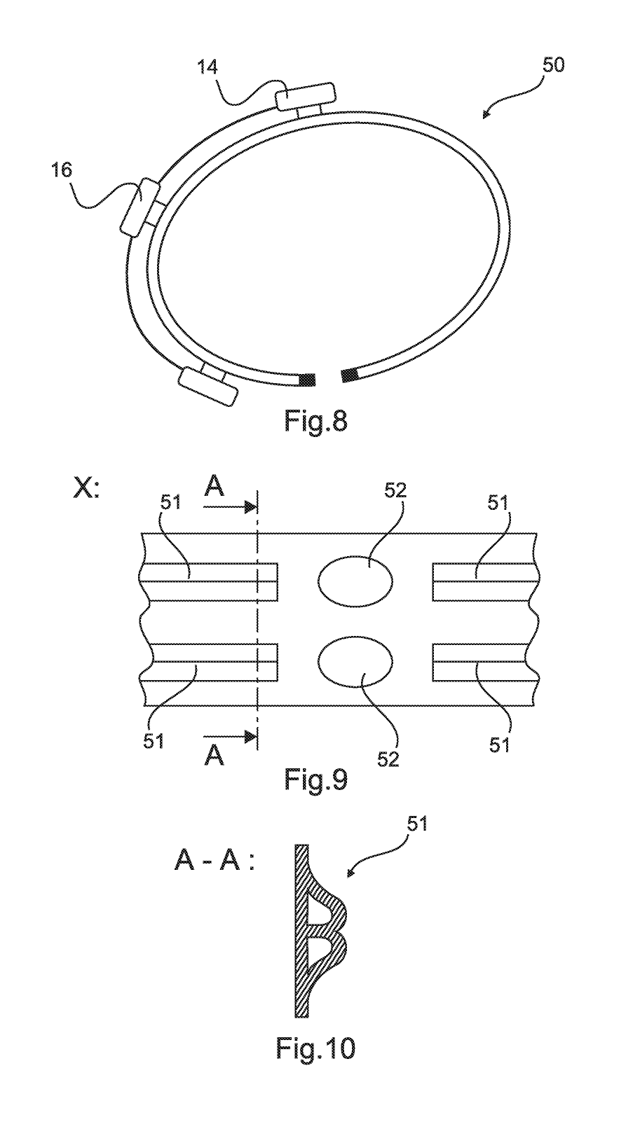

The control unit 14 can be fastened to a fastening unit 50 of the exoskeleton system 10 which, in FIG. 1, is designed as a belt worn by the person 1. The fastening unit 50 is designed as a kit for fastening the control unit 14 and a communication unit 16 to the exoskeleton system 10 or to the person 1 as will be described in more detail with reference to FIG. 8. The communication unit 16 is configured to wirelessly communicate with an external robot system or an external server with which the exoskeleton system 10 can be controlled.

FIG. 2 shows an exoskeleton system 10 having different exoskeleton units 11a, 12a, 33a, 34a, 35a, 36a, 37a, 38a, 39a, 40a, 41a, 42a, 43a, 44a, 45a, 46a, 47a, 48a such that the whole body of the person 1 is covered by exoskeleton units being arranged or allocated to different body parts of the person 1. At least a part of the exoskeleton units 11a, 12a, 33a, 34a, 35a, 36a, 37a, 38a, 39a, 40a, 41a, 42a, 43a, 44a, 45a, 46a, 47a, 48a is connected via connection units 15. In particular, one connection unit 15 connects two neighboring exoskeleton units 11a, 33a. The connection units 15 may comprise actuators or drive units for moving the exoskeleton units 11a, 12a, 33a, 34a, 35a, 36a, 37a, 38a, 39a, 40a, 41a, 42a, 43a, 44a, 45a, 46a, 47a, 48a relative to each other such that the corresponding body parts 11b, 12b, 33b, 34b, 35b, 36b, 37b, 38b, 39b, 40b, 41b, 42b, 43b, 44b, 45b, 46b, 47b, 48b of the exoskeleton units 11a, 12a, 33a, 34a, 35a, 36a, 37a, 38a, 39a, 40a, 41a, 42a, 43a, 44a, 45a, 46a, 47a, 48a can be moved or supported by the exoskeleton units 11a, 12a, 33a, 34a, 35a, 36a, 37a, 38a, 39a, 40a, 41a, 42a, 43a, 44a, 45a, 46a, 47a, 48a. There may be an actuator or drive unit in each connection unit 15 connecting two neighboring exoskeleton units 11a, 12a, 33a, 34a, 35a, 36a, 37a, 38a, 39a, 40a, 41a, 42a, 43a, 44a, 45a, 46a, 47a, 48a. However, it is possible that an actuator or drive unit may be arranged at the respective exoskeleton units 11a, 12a, 33a, 34a, 35a, 36a, 37a, 38a, 39a, 40a, 41a, 42a, 43a, 44a, 45a, 46a, 47a, 48a to be moved or supported.

There may be an exoskeleton unit 11a for a forearm of the person 1, an exoskeleton unit 12a for a shank of the person 1, an exoskeleton unit 33a for an upper arm 33a of the person 1, an exoskeleton unit 34a for another forearm of the person 1, an exoskeleton unit 35a for another upper arm of the person 1, an exoskeleton unit 36a for a femoral of the person 1, an exoskeleton unit 37a for another femoral of the person 1, an exoskeleton unit 38a for another shank of the person 1, an exoskeleton unit 39a for a shoulder region of the person 1, an exoskeleton unit 40a for a torso of the person 1, an exoskeleton unit 41a for a hip of the person 1, an exoskeleton unit 42a for a knee of the person 1, an exoskeleton unit 43a for another knee of the person 1, an exoskeleton unit 44a for a foot of the person 1, an exoskeleton unit 45a for another foot of the person 1, an exoskeleton unit 46a for a hand of the person 1, an exoskeleton unit 47a for another hand of the person 1 and an exoskeleton unit 48a for a head of the person 1.

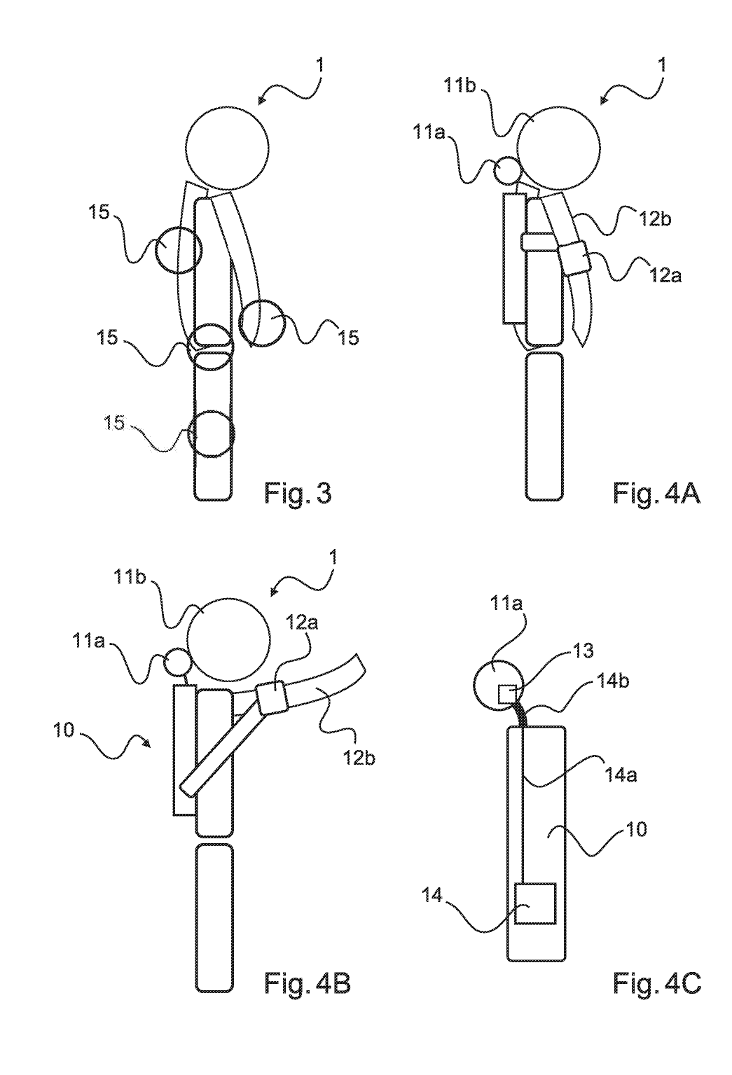

FIG. 3 shows typical locations for connection units 15 of an exoskeleton system according to an exemplary embodiment of the invention. Theses connection units 15 can also be referred to as exo-plug devices. The connection units 15 are located where two different exoskeleton units 11a, 33a are connected, for example at a fore arm-upper arm connection, at a spine-spine connection, at an upper body-lower body connection or at a lower body-knee connection. These connections 15 are controlled by the control unit 16 which is not shown in FIG. 3. The connections 15 can be independently or simultaneously controlled by the control unit 16. The connections 15 may be hangable and/or twistable. In other words, the connections may be foldable and therefore provide a flexible connection between different exoskeleton units.

FIG. 4A shows a person 1 wearing an exoskeleton system 10 with an arm support 12a. If the person 1 is moving the head 11b in a rearward direction in order to look in an upward direction and therefore moves the head 11b towards the neck, the detection unit 13 of the first exoskeleton unit 11a, e.g., the neck support detects this movement. The control unit 14 then activates and controls the second exoskeleton unit 12a, which is designed as an arm support for stabilizing and supporting the arm of the person 1 by moving the second body part 12b, e.g., the arm in an upward direction as shown in FIG. 4B. In this manner, the person 1 can be supported since an additional movement support for the arm is provided. The second exoskeleton unit 12a therefore reduces the effort to be applied by the person 1, for example if the person 1 needs to hold a heavy tool during an overhead work. Especially, during overhead works, the operator works in different heights. Depending on the height, his head is pressing against the neck support, e.g., the first exoskeleton unit 11a. If the worker looks up, the support in the arms will become stronger. The detection unit 13 is configured to measure a strain or bending of the neck support and sends this information to the control unit 14. The control unit 14 will then increase the arm support by controlling the second exoskeleton unit 12a as shown in FIG. 4B.

FIG. 4C shows the exoskeleton system 10 of FIGS. 4A and 4B without the person 1. The exoskeleton system 10 comprises a first exoskeleton unit 11a and a second exoskeleton unit 12a not shown in FIG. 4C. The Exoskeleton system 10 comprises an actuator or drive unit 14b which is controlled by the control unit 14. The exoskeleton system 10 further comprises a wiring 14a for connecting the detection unit 13 of the first exoskeleton unit 11a with the control unit 14 such that data about the condition of the first body part 11b, e.g., the head of the person 1 can be transmitted to the control unit 14. The data about the condition of the first body part 11b can be detected based on a movement of or force acting on the actuator or drive unit 14b. The wiring 14a also connects the control unit 14 with the actuator or drive unit 14b such that data about a desired condition of the first body part 11b or second body part 12b to be adjusted can be transmitted to the actuator or the drive unit 14b.

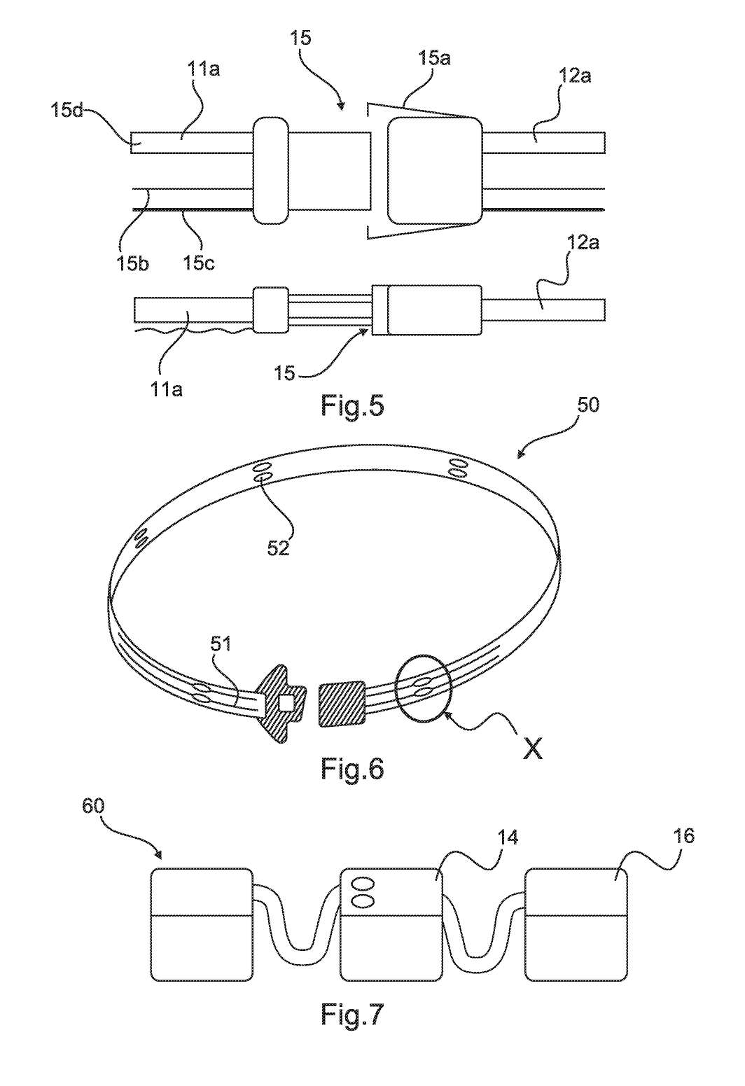

FIG. 5 shows two exoskeleton units 11a, 12a, e.g., the first exoskeleton unit 11a and the second exoskeleton unit 12a. The two exoskeleton units 11a, 12a are connected via one connection unit 15. The first exoskeleton unit 11a is mechanically connected to the second exoskeleton unit 12a via the mechanical connection unit 15. The mechanical connection unit 15 for the connection between the first exoskeleton unit 11a and the second exoskeleton unit 12a comprises an articulated joint. In this manner, a hangable and/or twistable connection 15 can be provided. The connections may therefore be foldable. Furthermore, the connection unit 15 comprises a pull linkage 15a for mechanically coupling the first exoskeleton unit 11a to the second exoskeleton unit 12a. The connection unit 15 may comprise connecting data cables 15b, power cables 15c, pneumatic hoses 15d or a combination thereof. Electrical power and/or a pneumatic can be used to drive the actuators, e.g., drive units 14b not shown in FIG. 5.

FIG. 6 shows a fastening unit 50 for fastening the control unit 14 shown in FIG. 1 to person 1. The fastening unit 50 is designed as a belt that is configured to be worn by person 1 and which is configured to fasten the control unit 14 as well as other equipment to person 1. Loops 51 for fastening wirings are integrated into the belt. The holes 52 visualized in FIG. 9 are also integrated into the belt such that wirings, in particular cables and electrical transmission lines can be led through the holes 52. Using the belt, it is therefore possible to carry necessary units and components as well as to store the wiring.

FIG. 7 schematically shows a control and communication kit 60 for the exoskeleton system 10. The kit 60 at least comprises the control unit 14 and the communication unit 16. The kit 60 can be fastened to the fastening unit 50 as shown in FIG. 8. In particular, FIG. 8 shows the fastening unit 50 with the control and communication kit 60 attached to it. The communication unit 16 and the control unit 14 can be moved along the belt. These components may be arranged within bags as shown in FIG. 7.

FIG. 9 shows the detailed view X of FIG. 6. In particular, FIG. 9 shows that the fastening unit 50, e.g., the belt, comprises holes 52 for leading wirings into or out of the exoskeleton system 10. Furthermore, the fastening unit 50 comprises loops 51 for leading wirings along the fastening unit 50 in a compact manner. The holes 52 can be used to connect or deflect the wirings.

FIG. 10 shows the cross-sectional view A-A of FIG. 9. Therein, it is recognizable that the fastening unit 50 comprises two separate leading loops 51 for leading the wiring.

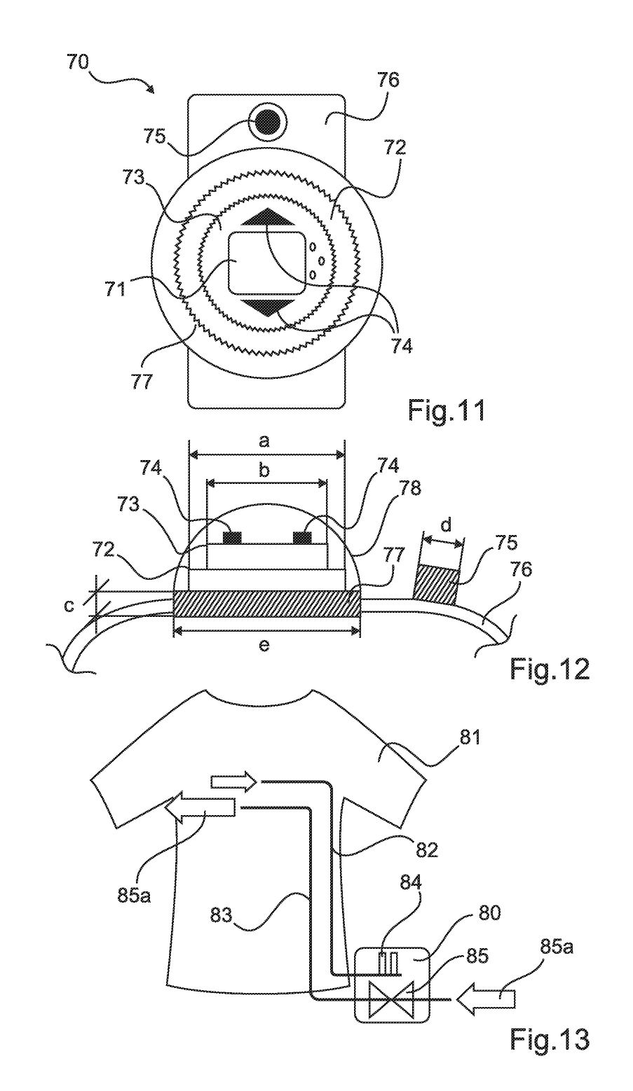

FIG. 11 shows a top view of a control device 70 for manually controlling the exoskeleton system 10. Therefore, a button or sensor is comprised by the control device 70 to enable the user to have manual control about the exoskeleton system 10. The detection device 13 may thus also be the sensor pressed manually by the user.

The control device 70 may be connected to the control unit 14 wirelessly or by cable. The control device 70 may be carried by the person 1 wearing the exoskeleton system 10. For example, the control device 70 can be fastened to a wrist of the person 1 in order to allow an easy control by the person. The control device 70 comprises a wrist band 76, two flat rotary switches 72, 73, two control buttons 74 and a display 71. Furthermore, the control device 70 comprises an emergency button 75 for switching off the entire exoskeleton system 10 in case of an emergency. If the emergency button 75 is pressed the entire system will immediately switch off. The rotary switches 72, 73 are mounted to a ground plate 77 which connects the wrist band 76 with the rotary switches 72, 73. The display 71 and the control buttons 74 are arranged on the second rotary switch 73. The first and second rotary switches are arranged one on top of the other as can be seen in FIG. 11. By means of the rotary switches 72, 73, the system settings, e.g., the system settings of the exoskeleton units, for example the arm support, can be changed. The first switch 72 changes the system settings strongly, whereas the second switch 73 is used for smooth changes. The control buttons 74 are used for switching the support program.

FIG. 12 shows a side view of the control device 70 of FIG. 11. The diameter a of the first rotary switch 72 may amount to about 38 mm and the diameter b of the second rotary 73 switch may amount to about 35 mm. The height c of the ground plate 77 may amount to about 3 mm. The diameter d of the emergency button 75 may amount to about 10 mm and the diameter e of the ground plate 77 may amount to about 40 mm. The heights of the rotary switches 72,73 may each amount to about 3 mm. As can be gathered form FIG. 12, the control device 70 may comprise a cover 78. The cover may be transparent. The cover 78 may also be removable such that the user can push the buttons or rotate the rotary switches 72, 73. The control device 70 may further comprise a Bluetooth interface, which is not shown in FIG. 12, for transferring data to and from the control unit 70. The data transfer may comprise a data transfer from the control device 70 to the actuators of the exoskeleton units 11a, 12a or the connection units 15.

FIG. 13 schematically shows a humidity control inside a garment 81 of a person 1 wearing an exoskeleton system 10 or inside the exoskeleton system 10. The person 1 is not shown in FIG. 13. Sensors of the detection unit 13 can be located at any place in the exoskeleton system 10. To reduce production and maintenance costs, the sensors can also be arranged in a centralized manner. The detection unit 13, e.g., the sensors, are configured to detect different features and conditions which indicate the need of support of a body part and based on which the level of support is adjusted. The measured values can be used together with user-specific data of the person 1 in order to provide a user-specific support that is optimized for the person 1 to be supported by the exoskeleton system 10. Sensors 84 for checking the temperature and/or the humidity may be located on the cooling T-shirt or preferably in a central temperature control unit 80 and/or a central humidity control unit 80. A suction valve 85 is used to pump an air flow 85a into the garment and/or exoskeleton system 10 in order to adjust the temperature or humidity inside the garment and/or exoskeleton system 10. A supply line 83 for supplying the air flow into the garment and/or into the exoskeleton system 10 may be a part of the temperature and/or the humidity control unit 80. Accordingly, a suction line 82 for pumping the air flow out of the garment and/or out of the exoskeleton system 10 may also be a part of the temperature and/or the humidity control unit 80 such that a temperature measurement can be carried out by the sensors 84.

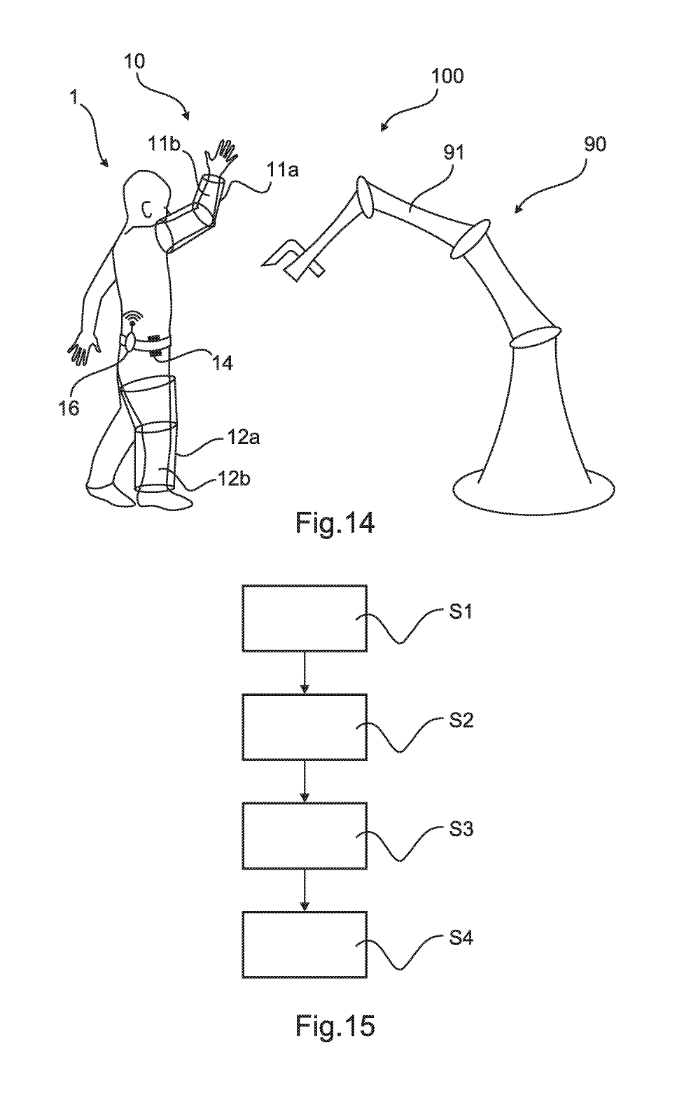

FIG. 14 shows a working environment 100 for supporting a person 1 during an installation process. The working environment 100 comprises the exoskeleton system 10 as shown in FIG. 1 or 2 and an external robot system 90. The exoskeleton system 10 further comprises the communication unit 16 for communicating with the external robot system 90. In the working environment 100, the external robot system 90 and the exoskeleton system 10 are arranged spatially separate. The control unit 14 is configured to control the second exoskeleton unit 12a based on a movement of the external robot system 10. In this manner, a collision between the robot system 90 and the exoskeleton system 10 can be avoided. It is possible that the control unit 14 of the exoskeleton system 10 recognizes during a movement of any of the exoskeleton units 11a, 12a that a collision of the exoskeleton unit 11a or 12a with the robot system 90, in particular with a robot arm 91 of the robot system 90 will occur if the movement of the exoskeleton units 11a, 12a continues. The control unit 14 then activates a countermovement of the exoskeleton units 11a, 12a or initiates a warning signal to person 1.

FIG. 15 shows a flow diagram of a method for supporting a person during an installation process. In a first step S1 of the method, an exoskeleton system 10 with a first exoskeleton unit 11a and a second exoskeleton unit 12a is provided. In a second step S2, the person 1 to be supported is equipped with the exoskeleton system 10 by attaching the first exoskeleton unit 11a to a first body part 11b of the person 1 and the second exoskeleton unit 12a to a second body part 12b of the person 1. In a third step S3, a threshold value for a maximum movement of the first body part 11b relative to the second body part 12b is defined. In a fourth step S4, the first exoskeleton unit 11a inhibits a movement of the first body part 11b when the threshold value for the maximum movement of the first body part 11b relative to the second body part 12b is exceeded.

While the invention has been illustrated and described in detail in the drawings and the foregoing description, such illustration and description are to be considered illustrative and exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the term “comprising” does not exclude other elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of protection.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An exoskeleton system for supporting a person during an installation process, comprising:
a first exoskeleton unit for stabilizing a first body part of the person;
a second exoskeleton unit for stabilizing a second body part of the person;
a detection unit configured to detect a condition of the first body part; and
a control unit configured to control the second exoskeleton unit based on the detected condition of the first body part such that a specified condition of the second body part is adjusted by the second exoskeleton unit.

2. The exoskeleton system according to claim 1, wherein the detection unit is configured to detect a movement of the first body part supported by the first exoskeleton unit, and
wherein the control unit is configured to adjust a movement of the second exoskeleton unit based on the detected movement of the first body part such that a movement of the second body part is supported by the adjusted movement of the second exoskeleton unit.

3. The exoskeleton system according to claim 1, wherein the control unit is configured to control the second exoskeleton unit based on the detected condition of the first body part only if the condition of the first body part is detected over a predetermined time span.

4. The exoskeleton system according to claim 1, wherein the control unit is configured to independently control the first exoskeleton unit and the second exoskeleton unit based on the detected condition of the first body part such that the condition of the second body part is independently supported by the second exoskeleton unit.

5. The exoskeleton system according to claim 1, wherein the detected condition of the first body part is selected from a group consisting of: a movement of the first body part, a movement direction of the first body part, a movement force of the first body part, a movement velocity of the first body part, a temperature of the first body part, a humidity of the first body part and a pulse rate.

6. The exoskeleton system according to claim 1, wherein the control of the second exoskeleton unit comprises a control selected from a group consisting of: a control of a movement of the second exoskeleton unit, a control of a movement direction of the second exoskeleton unit, a control of a movement velocity of the second exoskeleton unit, a control of a heat emission to the second body part via the second exoskeleton unit.

7. The exoskeleton system according to claim 1, wherein the first exoskeleton unit is arranged spatially separate to the second exoskeleton unit, or
wherein the first exoskeleton unit is mechanically connected to the second exoskeleton unit via at least one mechanical connection unit.

8. The exoskeleton system according to claim 7, wherein the at least one mechanical connection unit for the connection between the first exoskeleton unit and the second exoskeleton unit comprises an articulated joint.

9. The exoskeleton system according to claim 1, comprising:
a plurality of exoskeleton units, wherein each of the plurality of exoskeleton units is configured for stabilizing a corresponding body part, and
wherein the control unit is configured to independently control each of the exoskeleton units based on the detected condition of the first body part such that the corresponding body parts are independently supported by the plurality of exoskeleton units.

10. The exoskeleton system according to claim 1, wherein the control unit is configured to control the second exoskeleton unit based on boundary conditions such that a predetermined threshold value of the specified condition of the second body part is not exceeded.

11. The exoskeleton system according to claim 10, wherein the predetermined threshold of the specified condition of the second body part comprises user-specific data.

12. A working environment for supporting a person during an installation process, comprising:
an exoskeleton system according to claim 1; and
an external robot system;
wherein the exoskeleton system further comprises a communication unit for communicating with the external robot system which is arranged spatially separate to the exoskeleton system, and
wherein the control unit is configured to control the second exoskeleton unit based on a movement of the external robot system.

13. A method for supporting a person during an installation process, the method comprising:
providing an exoskeleton system with a first exoskeleton unit and a second exoskeleton unit;
equipping the person to be supported with the exoskeleton system by attaching the first exoskeleton unit to a first body part of the person and the second exoskeleton unit to a second body part of the person;
defining a threshold value for a maximum movement of the first body part relative to the second body part; and
inhibiting, by the first exoskeleton unit, a movement of the first body part when the threshold value for the maximum movement of the first body part relative to the second body part is exceeded.
